(19) United States
(12) Patent Application Publication
(10) Pub. No.: US 2021/0325863 A1
(43) Pub. Date: Oct. 21, 2021

(54) METHOD FOR MONITORING A MEASUREMENT POINT IN A PROCESS AUTOMATION SYSTEM

(71) Applicant: Endress+Hauser Process Solutions AG, Reinach (CH)

(72) Inventors: Werner THOREN, Steinen (DE); Robert KÖLBLIN, Lörrach (DE); Christian ISLER, Grellingen (CH); Hans-Jürgen HUBER, Freiburg (DE)

(21) Appl. No.: 17/272,530

(22) PCT Filed: Jul. 30, 2019
(86) PCT No.: PCT/EP2019/070460

§ 371 Date: Mar. 1, 2021

(30) Foreign Application Priority Data
Aug. 27, 2018 (DE) 10 2018 120 839.1

(51) Int. Cl. G05B 23/02; G01M 99/00

(52) U.S. Cl. CPC G05B 23/0235; G01M 99/00; G05B 23/027

(57) ABSTRACT

The present disclosure relates to a method for monitoring an automated plant including a plurality of field devices and a plurality of other plant components, wherein the field devices generate data and communicate with one another and with a superordinated unit via a communication network, comprising: continuously registering production data from the plant, wherein the production data represents quantities of produced products versus defined time intervals; calculating individual loading data for each plant component and field device, wherein the loading data represents a degree of loading for each plant component and field device per produced product; continuously summing the degree of loading for each plant component and field device based on the registered production data and based on the loading data; and creating a warning notification when the degree of loading of a field device or a plant component exceeds a threshold individually defined for each, respectively.

The invention relates to a method for monitoring a measurement point in an automated plant, wherein the measurement point is located at at least one plant component, for example, a container and/or a pipeline, in which a process medium is present, at least at times, which plant component is incorporated in a process, in which a product is made from a raw or starting material by the application of chemical, physical or biological procedures.

Known in the state of the art are field devices, which are used in industrial plants. Field devices are often applied in automation technology as well as in manufacturing automation. Referred to as field devices are, in principle, all devices, which are applied near to a process and which deliver, or process, process relevant information. Field devices are used for registering and/or influencing process variables. Serving for registering process variables are sensor systems. Such are used, for example, for pressure- and temperature measurement, conductivity measurement, flow measurement, pH measurement, fill level measurement, etc., and register the corresponding process variables, pressure, temperature, conductivity, pH value, fill level, flow, etc. Used for influencing process variables are actuators systems. Such are, for example, pumps or valves, which can influence the flow of a liquid in a tube or pipe or the fill level in a container. Besides the above mentioned measurement devices and actuators, referred to as field devices are also remote I/Os, radio adapters, and, in general, devices, which are arranged at the field level.

A large number of such field devices are produced and sold by the Endress+Hauser group of companies.

In modern industrial plants, field devices are, as a rule, connected with superordinated units via communication networks, such as, for example, fieldbusses (Profibus®, Foundation® Fieldbus, HART®, etc.). The superordinated units are control units, such as, for example, a PLC (programmable logic controller). The superordinated units serve, among other things, for process control, as well as for commissioning of field devices. The measured values registered by field devices, for example, by their sensors, are transmitted via the particular bus system to one or more superordinated units, which, in given cases, process the measured values further and forward them to the control station of the plant. The control station serves for process visualizing, process monitoring and process control via the superordinated units. In addition, also a data transmission from the superordinated unit via the bus system to the field devices is required, for example, for configuration and parametering of field devices as well as for operation of actuators.

In the context of Industry 4.0, or IIoT (“Industrial Internet of Things”), the data produced by field devices are also frequently obtained directly from the field with the help of so-called data conversion units, which are referred to, for example, as “edge devices” or “cloud gateways”, and automatically transmitted to a central, cloud-capable service platform, in which an application is located. The application offers, among other things, functions for visualizing and additional processing of the data stored in the database and can be accessed by a user by means of the Internet.

A failure, or defect, of a field device, or other plant component, for example, a container or a tube or pipe connection, causes, in given cases, much time lost, besides unwanted expense. Now and then, the running process must be interrupted and the affected field device, or the affected plant components, replaced or subjected to maintenance.

Modern field devices, which communicate via a fieldbus, deliver information concerning current device status. In the case of a failure, for example, a failure message is generated, which informs service personnel concerning what has happened. This function is, however, not available in older field devices, which still communicate via analog communication means, for example, via a 4-20 mA electrical current loop. Moreover, this function is executed in the case of an already arisen failure. An informing of an impending failure, so that predictive maintenance can occur, is not provided.

Based on the above, an object of the invention is to provide a method, which enables detecting an impending failure of a field device or other plant component in reliable manner before occurrence of the failure.

The object is achieved by a method for monitoring an automated plant, wherein a plurality of field devices and a plurality of other plant components are incorporated in the plant, wherein the field devices generate data, for example, measurement data, control data, calibration/parametering data, diagnosis-, history- and/or state data, and wherein the field devices can communicate with one another and with at least one superordinated unit by means of a first communication network, comprising:
continuous registering of production data from the plant, wherein the production data represents quantities of produced products versus defined time intervals;
calculating individual loading data for each of the plant components and each of the field devices, wherein the loading data represents a degree of loading for each of the plant components and each of the field devices per produced product;
continuous summing of the degree of loading for each of the plant components and for each of the field devices based on the registered production data and based on the loading data; and
creating a warning notification, when the degree of loading of a field device or a plant component exceeds a threshold individually defined for each plant component and each field device.

An advantage of the method of the invention is that failure of field devices and/or other plant components, such as, for example, containers, pipelines, etc., can be predicted in reliable manner. A basic idea of the method is that a current degree of loading is calculated for each of the field devices and other plant components. The degree of loading defines the degree to which such a field device or other plant component has been loaded, for example, mechanically, in the course of operation of the plant and can tend to fail after a certain time due to the loading.

For the calculating of the individual degrees of loading, production data are taken into consideration. These are registered in an external system, for example, in the control system of the plant. The production data contains the amount of products, which have been produced in the plant per unit time, for example, per day. Loading data are calculated from this production data. The loading data define the growth of the degree of loading for each of the field devices, and for each of the other plant components, per produced product. The calculating utilizes the particular type of field device, or other plant component, the type of product and the relevant manufacturing steps, and applications. If the manufacture of a product involves, for example, use of an aggressive process medium, then the degree of loading for a pipeline is, in given cases, greater than in the case of an application, where, for example, water flows through the pipeline as process medium.

The degree of loading is individually calculated for each field device and each of the other plant components. In such case, the degree of loading for a field device, or other plant component, is calculated as follows:

$$D {L}_{n} = {\sum }_{i = 1}^{m} {L}_{i , n}$$

DL is in such case the degree of loading for a field device or other plant component “n”. L is the loading, which has occurred in a time interval i (defined by the updating rate of the production data). “m” corresponds to the time period, when the calculating was performed, i.e. to the number of time intervals.

If the degree of loading of one of the field devices, or one of the other plant components, reaches a predetermined threshold, which can be different in each case, then a maintenance notification is created, which is delivered to service personnel, in order that the particular field device or the particular other plant component be checked accordingly, and, in given cases, maintenance be performed and/or an exchange made.

Field devices, which are suitable for use with the method of the invention, have already been described by way of example in the introductory portion of the description.

In an advantageous, further development of the method of the invention, it is provided that environmental data are registered supplementally, for example, weather data, which enter into the calculating of the loading data, i.e. into the summing of the degree of loading for each of the plant components and for each of the field devices. Besides weather data, use of other environmental data, such as, for example, concentrations of deleterious substances in the air, water levels, water temperatures, etc., is also possible. These additional data form a factor, which is used for the continuous summing of the degree of loading in a time interval. The factor can, for example, for high and low temperatures, be higher than would be used for moderate temperatures. In such case, the degree of loading for a field device, or other plant component, is calculated as follows:

$$D {L}_{n} = {\sum }_{i = 1}^{m} {a}_{i , n} \cdot {L}_{i , n}$$

“a” corresponds, in such case, to the factor for a time interval, wherein the environmental data are correlated to the particular time intervals i.

In a first advantageous variant of the method of the invention, it is provided that the thresholds for each of the plant components and for each of the field devices are determined during commissioning of the respective plant component, or the respective field device. This is for example, performed manually. The particular threshold is, for example, different for different field device types, or types of other plant components, and differs depending on application provided for a field device or other plant component.

In a second advantageous variant of the method of the invention, it is provided that the thresholds for each of the plant components and for each of the field devices are determined by comparison with plant components, or field devices, in other plants of similar type. In this way, the experience of other plants, which have similar applications for field devices, or other plant components, can be accessed.

In a preferred embodiment of the second variant of the method of the invention, it is provided that the thresholds are continuously recalculated, or updated. The threshold set, in each case, corresponds thus to the relevant accumulations of experience. Also, possible necessary connections can be made available rapidly for all plants, and the thresholds of the field devices and other plant components installed in these plants can be updated.

In an advantageous embodiment of the method of the invention, it is provided that the registering of the production data, the calculating of the loading data, the summing of the degrees of loading, the creation of maintenance notifications and/or the determining, or recalculating, or updating, of the thresholds is performed by a server, for example, by an application in the server, which server is connected for communication with the communication network of the plant, for example, via the Internet. Provided to the server for this are the production data. For example, the control station of the plant provides the production data to the server.

The invention will now be explained in greater detail based on the appended drawing, the sole FIGURE of which shows as follows:

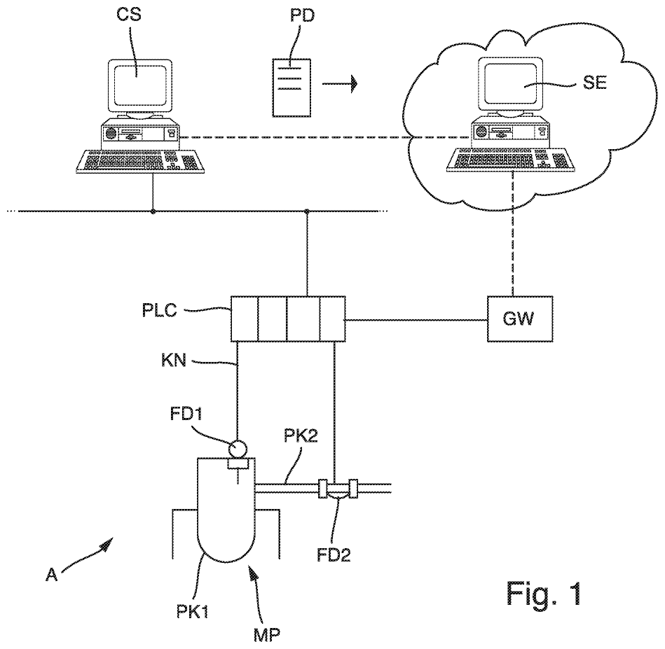

FIG. 1 an example of an embodiment of the method of the invention.

FIG. 1 shows a measurement point MP of an automated process plant P. Such is composed of plant components PK in the form of a tank PK1 and pipeline PK2 connected to an outlet of the tank PK1. For measuring fill level of the tank PK1, the measurement point includes a field device FD1, for example, a fill level measurement device operating by means of radar and mounted on the tank PK1. For measuring flow velocity of a process medium flowing through the pipeline PK2, the measurement point MP includes a field device FD2, for example, a flow measurement device working according to the Coriolis principle and inserted into the pipeline PK2.

Each of the field devices FD1, FD2 is connected for communication by means of a 4-20 mA electrical current loop or alternatively by means of a fieldbus with a superordinated unit PLC, which queries measured values of the field devices FD1, FD2 and transmits such by means of an additional network segment to the control station CS of the plant. The totality all network segments (the 4-20 mA electrical current loop, or the fieldbus, and the other network segment) are referred to in the following as a communication network KN.

The superordinated unit is connected with a gateway GW, which registers the process values transmitted by field devices FD1, FD2 to the superordinated unit PLC and provides the process values via the Internet to a server. The server is embodied to execute applications. An example of an application is a plant asset management system, which manages assets and/or inventory of the plant P.

In the following, the method of the invention for predictive failure detection of a field device FD1, FD2 or other plant component PK1, PK2 will now be described:

The shown measurement point MP is located in a part of a method, in which a product is made from a raw or starting material by the application of chemical, physical or biological procedures. In this portion of the method, at least one product is produced from at least one reactant. The total quantity product is registered in defined time intervals, for example, daily or hourly, and stored as production data PD in the control station CS. As soon as new production data PD are available, these are transmitted from the control station CS to the server SE.

The server SE then calculates for each of the field devices FD1, FD1, and for each of the other plant components PK1, PK2 an individual degree of loading, which corresponds to the individual demands that have been placed upon an item, and thus to its wear. The loading data define the growth of the degree of loading per field device FD1, FD2 and other plant component PK1, PK2, per produced product.

Additionally, for example, the control station or an additional, external server makes available to the server SE environmental data, for example, weather data, which is then used by the server SE as a factor for calculating degree of loading. The factor can be, for example, higher for high and low temperatures than it would be for moderate temperatures. In particular, the current degree of loading for a field device FD1, FD2, or other plant component PK1, PK2, is calculated as follows:

$$D {L}_{n} = {\sum }_{i = 1}^{m} {a}_{i , n} \cdot {L}_{i , n}$$

DL corresponds, in such case, to the degree of loading for a field device FD1, FD2, or for a plant component PK1, PK2. “n” corresponds to the “number” of a field device FD1, FD2, or a plant component PK1, PK2. L corresponds to the loading, which has occurred in a time interval i (defined by the updating of the production data). “m” corresponds to the time period, over which the calculating was performed, i.e. the number of time intervals. “a” corresponds, in such case, to the factor for a time interval, wherein the environmental data are correlated with the time intervals i.

If the degree of loading of one of the field devices, or one of the other plant components, reaches a predetermined threshold, which can be different for each case, then a maintenance notification is created, which is sent to the control station CS, in order that the particular field device FD1, FD2 or the particular other plant components PK1, PK2 be checked accordingly and, in given cases, maintained and/or exchanged.

A concrete example is the production of acids. From the production data “amount” and “concentration”, an integral degree of corrosion can be determined, which can act disadvantageously on the functioning of the plant components PK1, PK2.

The example of an embodiment shown in FIG. 1 is only by way of example. Besides the above examples of field devices FD1, FD2 and plant components PK1, PK2, other types of field devices FD1, FD2 and plant components PK1, PK2 can be used in the method of the invention.

### LIST OF REFERENCE CHARACTERS

P automated plant
PK1, PK2 plant components
FD1, FD2 field devices
GW gateway
KN communication network
PD production data
SE server
PLC superordinated unit

1-6. (canceled)

7. A method for monitoring an automated plant, wherein the plant comprises a plurality of field devices and a plurality of other plant components, wherein the field devices are configured to generate data, including measurement, control, calibration, parametering, diagnosis, historical and/or state data, and wherein the field devices are configured to communicate with one another and with at least one superordinated unit via a communication network, the method comprising:
continuously registering production data from the plant, wherein the production data includes quantities of produced products versus defined time intervals;
calculating individual loading data for each of the field devices and each of the other plant components, wherein the loading data represents a degree of loading for each field device and each other plant component per produced product;
continuously summing the degree of loading for each field device and each other plant component based on the registered production data and based on the loading data; and
generating a warning notification when the degree of loading of a field device of the plurality of field devices or a plant component of the plurality of other plant components exceeds a threshold individually defined for each respective field device or other plant component.

8. The method of claim 7, wherein environmental data are registered and included in the calculating of the individual loading data for each of the field devices and each of the other plant components.

9. The method of claim 7, wherein the individually defined thresholds for each of the field devices and each of the other plant components are determined during commissioning of the respective field device or respective other plant component.

10. The method of claim 7, wherein the individually defined thresholds for each of the field devices and for each of the plant components are determined by comparison with field devices or other plant components employed in other plants of similar type.

11. The method of claim 10, wherein the individually defined thresholds are continuously recalculated or updated.

12. The method of claim 7, wherein the registering of the production data, the calculating of the loading data, the summing of the degrees of loading and/or the generating of maintenance notifications are performed by a server, which server is connected for communication with the communication network of the plant.

13. The method of claim 12, wherein the individually defined thresholds for each of the field devices and each of the other plant components are determined:
during commissioning of the respective field device or respective other plant component; or
by comparison with field devices or other plant components employed in other plants of similar type, and
wherein the determining of the individually defined thresholds is performed by the server.

14. The method of claim 13, wherein the individually defined thresholds are continuously recalculated or updated, and wherein the recalculating or updating of the individually defined thresholds is performed by the server.
